(19) United States
(12) Patent Application Publication
(10) Pub. No.: US 2026/0127707 A1
(43) Pub. Date: May 7, 2026

(54) SERVER AND METHOD FOR SUPER-RESOLUTION AND SYSTEM INCLUDING THE SAME

(71) Applicant: MEISSA INC., Seoul (KR)

(72) Inventors: Hyun Sun PARK, Seoul (KR); Young Ju Lee, Seoul (KR); Yeo Wool Lee, Seoul (KR); Yong Hyub Sakong, Seoul (KR); Dong Chul Kim, Seoul (KR); Ah Rom Goo, Seoul (KR); Myung Hoon Kang, Seoul (KR)

(73) Assignee: MEISSA INC., Seoul (KR)

(21) Appl. No.: 19/077,377

(22) Filed: Mar. 12, 2025

(30) Foreign Application Priority Data
Nov. 4, 2024 (KR) 10-2024-0153964

(51) Int. Cl. G06T 3/4053; G06T 3/4046; G06T 7/11

(52) U.S. Cl. CPC G06T 3/4053; G06T 3/4046; G06T 7/11; G06T 2200/24; G06T 2207/10016; G06T 2207/10032; G06T 2207/20081; G06T 2207/20084; G06T 2207/20092; G06T 2207/30184; G06T 2207/30188

(57) ABSTRACT

The present invention relates to a server and method for super-resolution that may vary a super-resolution method for video data (e.g., satellite image, aerial video, drone video, etc.) according to a user's request, and a system including the same. The super-resolution server may include a data collection module that receives video data and requirement information related to the user's needs for the video data, a super-resolution module that super-resolves the video data according to the requirement information to generate a high-resolution satellite image, and an output module that outputs the high-resolution satellite image and reliability information on the high-resolution satellite image.

### CROSS-REFERENCE TO RELATED APPLICATION

This application claims priority to and the benefit of Korean Patent Application No. 10-2024-0153964, filed on Nov. 4, 2024, the disclosure of which is incorporated herein by reference in its entirety.

### BACKGROUND

### 1. Field of the Invention

The present invention relates to a server and method for super-resolution and a system including the same.

More particularly, the present invention relates to a server and method for super-resolution that may vary a super-resolution method for video data (e.g., a satellite image, aerial video, drone video, etc.) according to a user's request and a system including the same.

### 2. Discussion of Background Art

The contents described in this Background Art merely provide background information with respect to the present embodiment and do not constitute the related art.

Recently, video data, such as satellite images, aerial images, and drone images, are being utilized to acquire information on buildings, roads, nature, etc. Such video data is being utilized in various ways, such as detecting the possibility of forest fires and determining a vegetation index.

In this case, since a satellite image is captured from a high altitude above the ground, there may be cases where data analysis is not made easy due to low resolution when performing the data analysis using the satellite image. In this case, super-resolution, which involves a task of increasing the resolution of the satellite image, is performed. However, in general, when super-resolution of the satellite image is performed, only the post-processing of the known method is performed in a batch, and no technological development is being made for performing super-resolution in a manner that matches the user's needs.

Accordingly, there is a sufficient need for super-resolution-related technology that reflects user requirements.

### SUMMARY OF THE INVENTION

The present invention is directed to providing a server and method for super-resolution that can vary the super-resolution method according to a user's request, and a system including the same.

More specifically, the present invention is directed to providing a server and method for super-resolution that can vary the super-resolution method depending on whether user requirements are simple super-resolution, object analysis, area analysis, or band analysis to ensure both reliability of the super-resolution results and visibility of the super-resolution effects, and a system including the same.

In addition, the present invention is directed to providing a server and method for super-resolution capable of additionally displaying object reliability according to super-resolution to enable users to secure reliability in super-resolution results, and a system including the same.

Objects of the present disclosure are not limited to the above-described objects, and other objects and advantages of the present disclosure that are not described may be understood by the following description and will be more clearly appreciated by exemplary embodiments of the present disclosure. In addition, it may be easily appreciated that aspects and advantages of the present disclosure may be realized by means mentioned in the claims and a combination thereof.

According to an aspect of the present invention, there is provided a super-resolution server, including a data collection module that receives video data and requirement information related to user's needs for the video data, a super-resolution module that super-resolves the video data according to the requirement information to generate a high-resolution satellite image and an output module that outputs a high-resolution satellite image and reliability information related to the high-resolution satellite image.

The data collection module may receive the video data from an external database that stores and manages the video data and receive the requirement information from a user terminal for the user.

The requirement information may include coordinate information related to a coordinate area that a user wants to analyze and purpose information related to a purpose that the user wants to achieve through the high-resolution satellite image.

The purpose information may include simple super-resolution that refers to only super-resolution of the video data and a selection of the user of one of the special analyses that refers to specific data analysis through the video data.

The super-resolution module may include an object segmentation unit that segments an object included in the video data to generate a segmentation result for the corresponding video data, a method determination unit that determines a super-resolution method which is a method of performing the super-resolution based on the segmentation result and the requirement information, and a generation unit that super-resolves the video data according to the determined super-resolution method to generate the high-resolution satellite image.

The object segmentation unit may segment the object using a segmentation model trained in advance based on a neural network to generate the segmentation result.

The segmentation model may include a semantic segmentation model.

The method determination unit may determine one of a first method based on up-scaling and a second method based on a high-resolution model using the neural network as the super-resolution method, and the high-resolution model may include a generative artificial intelligence model.

The method determination unit may determine the super-resolution method based on the purpose information included in the requirement information.

When the purpose information constitutes the simple super-resolution, the method determination unit may determine the second method to be the super-resolution method.

When the purpose information constitutes object analysis among the special analyses, the method determination unit may determine the second method to be the super-resolution method.

When the purpose information constitutes area analysis or band analysis for a specific target among the special analyses, the method determination unit may determine a result of combining the first method and the second method to be the super-resolution method.

The method determination unit may determine the first method to be the super-resolution method for some of a plurality of regions included in the segmentation result and determine the second method to be the super-resolution method for some regions other than the some of the plurality of regions.

The method determination unit may determine a region of interest among the plurality of regions included in the segmentation result based on the specific target, determine the first method to be the super-resolution method for the determined region of interest, and determine the second method to be the super-resolution method for other regions excluding the region of interest.

When the specific object is a road and a type of the special analysis is area analysis of the road, the method determination unit may determine a region including the road to be the region of interest, determine the first method to be the super-resolution method for the region of interest including the road, and determine the second method as to be super-resolution method for other regions excluding the road.

When the specific target is vegetation and a type of the special analysis is band analysis of the vegetation, the method determination unit may determine a region including the vegetation to be the region of interest, determine the first method to be the super-resolution method for the region of interest including the vegetation, and determine the second method to be the super-resolution method for other regions excluding the vegetation.

The output module may generate the reliability information based on a difference between the video data and the high-resolution satellite image.

The output module may compare the video data with the high-resolution satellite image to generate a probability of correspondence between an object included in the video data and the object included in the high-resolution satellite image as the reliability information.

According to another aspect of the present invention, there is provided a super-resolution server, including a memory that stores at least one instruction and at least one processor that executes the at least one instruction, in which the processor may receive video data and requirement information related to user's needs for the video data, super-resolve the video data according to the requirement information to generate a high-resolution satellite image, and output the high-resolution satellite image and reliability information for the high-resolution satellite image.

According to still another aspect of the present invention, there is provided a super-resolution system, including an external database that stores video data, a super-resolution server that communicates with the external database to receive the video data, a user terminal that transmits requirement information related to user's needs for the video data to the super-resolution server, and a communication network that performs communication between the external database, a user terminal and the super-resolution server, in which the super-resolution server may include a memory storing at least one instruction and at least one processor that executes the at least one instruction, and the processor may receive the video data and the requirement information, super-resolve the video data according to the requirement information to generate a high-resolution satellite image, and output the high-resolution satellite image and reliability information for the high-resolution satellite image.

### BRIEF DESCRIPTION OF DRAWINGS

The above and other objects, features, and advantages of the present invention will become more apparent to those of ordinary skill in the art by describing exemplary embodiments thereof in detail with reference to the accompanying drawings, in which:

FIG. 1 is a diagram illustrating a super-resolution system according to some embodiments of the present invention;

FIG. 2 is a diagram for describing a neural network structure of a neural network model used by a super-resolution server according to some embodiments of the present invention;

FIG. 3 is a block diagram of the super-resolution server according to some embodiments of the present invention;

FIG. 4 is a diagram illustrating video data according to some embodiments of the present invention;

FIGS. 5 to 7 are diagrams for describing requirement information according to some embodiments of the present invention;

FIG. 8 is a block diagram of a super-resolution module according to some embodiments of the present invention;

FIG. 9 is a detailed block diagram of the super-resolution module according to some embodiments of the present invention;

FIG. 10 is a conceptual diagram for describing an operation of the super-resolution module according to some embodiments of the present invention;

FIG. 11 is a detailed block diagram of an object segmentation unit included in the super-resolution module according to some embodiments of the present invention;

FIGS. 12 and 13 are diagrams for describing a learning phase and an inferencing phase of a segmentation model used by the object segmentation unit according to some embodiments of the present invention;

FIG. 14 is a diagram for describing a super-resolution method according to some embodiments of the present invention;

FIG. 15 is a diagram for describing an operation of a method determination unit when purpose information constitutes simple super-resolution according to some embodiments of the present invention;

FIG. 16 is a diagram for describing the operation of the method determination unit when the purpose information constitutes object analysis according to some embodiments of the present invention;

FIG. 17 is a diagram for describing the operation of the method determination unit when the purpose information constitutes area analysis or band analysis according to some embodiments of the present invention;

FIG. 18 is a conceptual diagram for describing the operation of the method determination unit when the purpose information constitutes road area analysis according to some embodiments of the present invention;

FIG. 19 is a conceptual diagram for describing the operation of the method determination unit when the purpose information constitutes vegetation band analysis according to some embodiments of the present invention;

FIG. 20 is a block diagram of an output module according to some embodiments of the present invention;

FIG. 21 is a diagram for describing reliability information according to some embodiments of the present invention;

FIG. 22 is a block diagram of a super-resolution server according to some other embodiments of the present invention;

FIG. 23 is a flowchart of the super-resolution method according to some embodiments of the present invention;

FIG. 24 is a detailed flowchart of operation S100 of FIG. 23 according to some embodiments of the present invention;

FIG. 25 is a detailed flowchart of operation S200 of FIG. 23 according to some embodiments of the present invention;

FIG. 26 is a detailed flowchart of operation S210 of FIG. 25 according to some embodiments of the present invention;

FIG. 27 is a detailed flowchart of operation S220 of FIG. 25 according to some embodiments of the present invention;

FIG. 28 is a detailed flowchart of operation S223 of FIG. 27 according to some embodiments of the present invention;

FIG. 29 is a detailed flowchart of operation S300 of FIG. 23 according to some embodiments of the present invention; and

FIG. 30 is a diagram for describing a hardware implementation of the super-resolution server according to some embodiments of the present invention.

### DETAILED DESCRIPTION OF EXEMPLARY EMBODIMENTS

Terms or words used in this specification and the patent claims should not be interpreted as limited to their general or dictionary meanings. In accordance with the principle that the inventor can define the concept of terms or words in order to describe his or her own invention in the best way, these terms or words should be interpreted as having meanings and concepts that are consistent with the technical idea of the present invention. In addition, the configurations described in the embodiments and drawings described in the present specification represent merely one embodiment in which the present invention is realized, but do not represent all of the technical ideas of the present invention, so the present invention should be construed as including various equivalents and modification and application examples that can replace the technical ideas of the present invention at the time of the filing of this application.

The terms such as “first,” “second,” “A,” and “B” used in the present specification and claims may be used to describe various components, but these components are not to be limited by these terms. The terms are used to distinguish one component from another component. For example, the first component may be named the second component, and the second component may also be similarly named the first component without departing from the scope of the present disclosure.

The terms used in the present specification and claims are used only in order to describe specific embodiments rather than limiting the present disclosure. Singular forms include plural forms unless the context clearly indicates otherwise. It should be understood that terms such as “include” or “have” in this application do not preliminarily exclude the presence or addition of features, numbers, steps, operations, components, parts, or combinations thereof described in the specification.

Unless indicated otherwise, it is to be understood that all the terms used in the specification including technical and scientific terms have the same meaning as those that are generally understood by those who skilled in the art.

Terms generally used and defined by a dictionary should be interpreted as having the same meanings as meanings provided within a context of the related art and should not be interpreted as having ideal or excessively formal meanings unless being clearly defined otherwise in the present specification.

In addition, each configuration, process, process, method, etc. included in each embodiment of the present invention may be technically shared within a scope in which there is no contradiction with respect to each other.

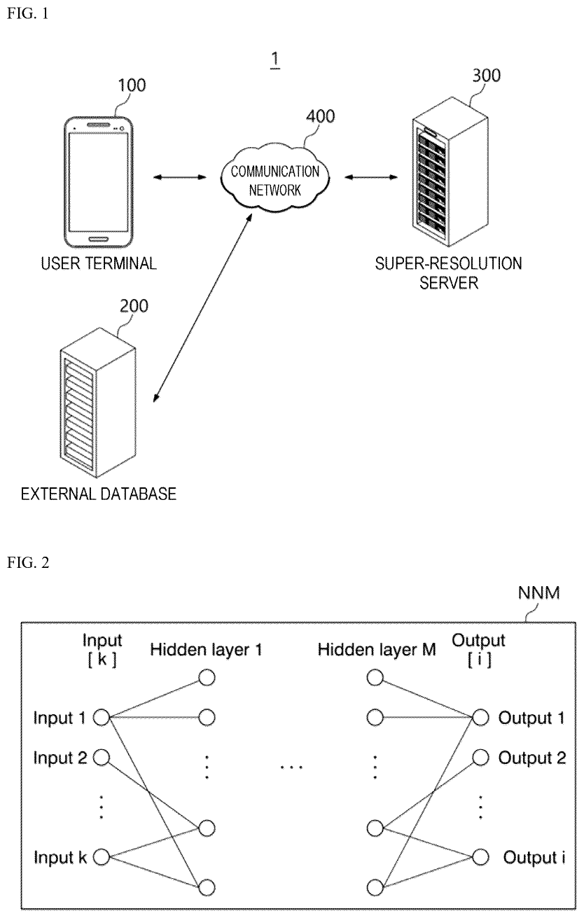

Hereinafter, a server and method for super-resolution and a system including the same according to some embodiments of the present invention will be described with reference to FIGS. 1 to 30.

FIG. 1 is a diagram illustrating a super-resolution system according to some embodiments of the present invention.

Referring to FIG. 1, a super-resolution system 1 according to some embodiments of the present invention may include a user terminal 100, an external database 200, a super-resolution server 300 (hereinafter referred to as “server”), and a communication network 400.

The user terminal 100 is a terminal for a user who wishes to search for or receive video data through the server 300. In this case, the video data may include at least one of a satellite image captured from a satellite, an aerial image captured from an aircraft, and a drone image captured from a drone, but the embodiment of the present invention is not limited thereto.

The user terminal 100 may transmit requirement information related to super-resolution of video data to the server 300 and receive a high-resolution satellite image corresponding thereto. In this case, the user terminal 100 may communicate with the server 300 through a video data program in the form of a web or app provided by the server 300.

As provided in some examples, the user terminal 100 may transmit user requirement information related to the super-resolution method of the video data to the server 300 through a user's response (e.g., click, touch input, etc.) to a selection interface provided from the server 300 and may thus receive the high-resolution satellite image as a result of performing the super-resolution of the video data from the server 300.

Meanwhile, the user terminal 100 may be in the form of various types of electronic devices such as a smart phone, a computer, a notebook PC, and a wearable device, a workstation, a data center, an internet data center (IDC), a direct attached storage (DAS) system, a storage area network (SAN) system, a network attached storage (NAS) system, and a redundant array of inexpensive disks or redundant array of independent disks (RAID) system, but the embodiment of the present invention is not limited thereto.

The external database 200 may be a database that stores, preserves, manages, and/or transmits a plurality of video data that are the basis of the super-resolution.

For example, the external database 200 may handle at least one of the satellite image captured from a satellite, the aerial image captured from an aircraft, and the drone image captured from a drone, but the embodiment of the present invention is not limited thereto. In this case, the video data transmitted by the external database 200 to the server 300 may be low-resolution video, i.e., low-resolution video data.

For some examples, the external database 200 may receive video data captured through a satellite and the like and transmit the received video data to the server 300. Thereafter, when the super-resolution is completed by the server 300, the external database 200 may receive, store, and manage the high-resolution satellite image as the result of the super-resolution.

In this case, the external database 200 may store, retain, manage, and transmit various types of low-resolution video data. For example, the external database 200 may handle an electro-optical video and a multi-spectral video. In this case, the electro-optical video may include a red, green, blue (RGB) video, and the multi-spectral video may include a near-infrared (NIR) video, a short-wave infrared (SWIR) video, a mid-wave infrared (MWIR) video, a long-wave infrared (LWIR) video, etc., but the embodiment of the present invention is not limited thereto.

Meanwhile, the external database 200 may be in the form of various types of electronic devices such as a smart phone, a computer, a notebook PC, and a wearable device, a workstation, a data center, an internet data center (IDC), a direct attached storage (DAS) system, a storage area network (SAN) system, a network attached storage (NAS) system, and a redundant array of inexpensive disks or redundant array of independent disks (RAID) system, but the embodiment of the present invention is not limited thereto.

However, unlike the above description, the super-resolution system 1 according to some embodiments of the present invention may be implemented with the external database 200 being omitted. In this case, the video data stored, managed, and transmitted by the external database 200 may be stored and managed by the database included in the server 300.

The server 300 may super-resolve the video data received from the external database 200 based on the requirement information received from the user terminal 100 to generate the high-resolution satellite image. In other words, the server 300 may perform super-resolution the video data received from the external database 200 based on the requirement information received from the user terminal 100 to generate the high-resolution satellite image. A detailed description thereof will be described below.

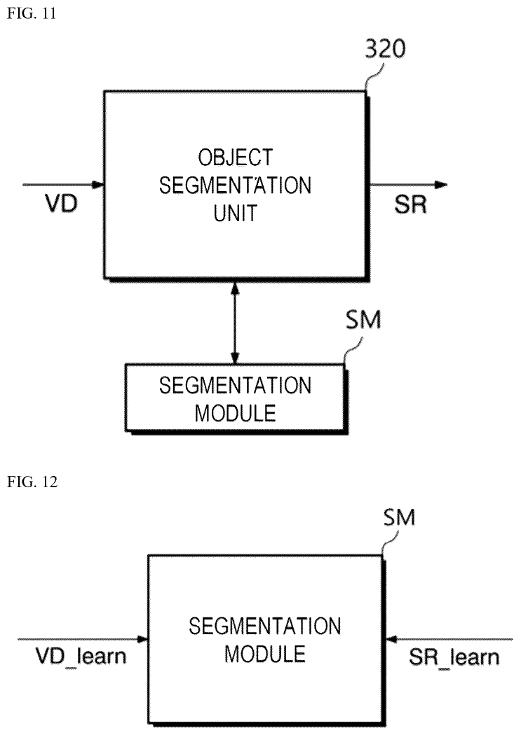

In this case, the server 300 may super-resolve the video data based on artificial intelligence (AI) technology. For example, the server 300 may super-resolve the video data using a deep learning method and structure. For example, the server 300 may perform the super-resolution using a pre-trained neural network model. In this case, as described below, the neural network model used by the server 300 may include a segmentation model (SM of FIG. 11), a high-resolution model (HRM of FIG. 14), etc.

To describe this matter in more detail, the deep learning technology, which is a type of machine learning, is a technology that performs training by descending to a deep level in multiple stages based on data. In other words, the deep learning refers to a set of machine learning algorithms that extract key data from a plurality of data while increasing the stages.

As provided in some examples, the neural network may use various known deep learning structures. For example, the neural network may use structures such as a convolutional neural network (CNN), a recurrent neural network (RNN), a deep belief network (DBN), a graph neural network (GNN), a generative adversarial network (GAN), a transformer, and an autoencoder.

Specifically, the CNN is a model that simulates a human brain function based on the assumption that when a person recognizes an object, basic features of the object are extracted, and then the brain performs complex calculations to recognize the object based on the results. The CNN may include known structures such as LeNet, AlexNet, VGGNet, GoogleNet, and ResNet, but is not limited thereto.

The RNN is widely used in natural language processing and the like and is an effective structure for processing time-series data that changes over time. The RNN may construct an artificial neural network structure by stacking layers at each moment.

The DBN is a deep learning structure that is composed of multiple layers of a restricted Boltzman machine (RBM) that represents a deep learning technique. When the RBM training is repeated to reach a certain number of layers, a DBN with the corresponding number of layers may be composed.

The graphic neural network (hereinafter, GNN) represents an artificial neural network structure implemented in a manner of deriving similarity and feature points between modeling data using modeling data modeled based on data mapped among specific parameters.

The generative adversarial network (hereinafter, GAN) represents an artificial neural network structure that creates new data with a form similar to the input data using a generative neural network and a discriminative neural network. The GAN may include the known deep convolutional GAN (DCGAN), conditional GAN (CGAN), Wasserstein GAN (WGAN), style-based GAN (StyleGAN), CycleGAN, etc., but the embodiment of the present invention is not limited thereto.

The transformer is an artificial neural network with an encoder-decoder structure that utilizes attention and may grasp the overall meaning between an input sequence and an output sequence. The transformer may use an attention mechanism to allow all elements of the input sequence to affect the output sequence, so both the encoder and decoder may consider the entire sequence. The transformer may use not only natural language and time series data, but also an image as input as a result of patching an image.

The auto-encoder is a deep learning structure that performs the role of extracting and reconstructing data features. Typically, the auto-encoder includes an encoder that compresses an input value and a decoder that restores the compressed data. The encoder converts the input value into a low-dimensional latent representation, and the decoder restores the latent representation to the same dimension as the input value. In this case, the encoder and decoder may each be composed of a multilayer perceptron (MLP). To train the autoencoder, the input data is input, and weights and biases are trained in a way that minimizes a difference between the output value and the input value. The autoencoder trained in this way may extract the features of the input data well and restore noisy input data. The autoencoder is mainly utilized in the fields of data compression, dimension reduction, noise removal, data generation, etc. and may also be utilized in the fields of image recognition, natural language processing, voice recognition, etc.

Meanwhile, the artificial neural network training of the neural network model used by the server 300 may be performed by adjusting a weight (adjusting a bias value if necessary) of a connection line between nodes so that the desired output is generated for the given input. In addition, the artificial neural network may continuously update the weight value through training. In addition, a method such as back propagation may be used for training the artificial neural network.

In this case, as the machine learning method of the artificial neural network, unsupervised learning, semi-supervised learning, supervised learning, etc. may be used. In addition, the neural network model may be controlled to automatically update the artificial neural network structure for outputting the analysis data after training according to the settings. Hereinafter, the neural network model used by the server 300 according to some embodiments of the present invention will be described with reference to FIG. 2.

FIG. 2 is a diagram for describing a neural network structure of a neural network model used by a super-resolution server according to some embodiments of the present invention.

Referring to FIGS. 1 and 2, the server 300 according to some embodiments of the present invention may super-resolve the video data using a neural network model (hereinafter referred to as “NNM”). In this case, as described below, the NNM may include the segmentation model (SM of FIG. 11), the high-resolution model (HRM of FIG. 14), etc.

As provided in some examples, the NNM may include an input layer, an output layer, and M hidden layers arranged between the input layer and the output layer.

Here, weights may be set for edges connecting nodes of each layer. The presence or absence of these weights or edges may be added, removed, or updated during the training process. Therefore, weights of nodes and edges arranged between k input nodes and i output nodes may be updated during the training process.

Before the NNM performs training, all nodes and edges may be set to an initial value. However, when information is input cumulatively, the weights of the nodes and edges may be changed, and in this process, matching may be achieved between parameters input as training factors and values assigned to the output nodes.

In addition, when using a cloud server, the NNM may receive and process a large number of parameters. Therefore, the NNM may perform training based on massive data.

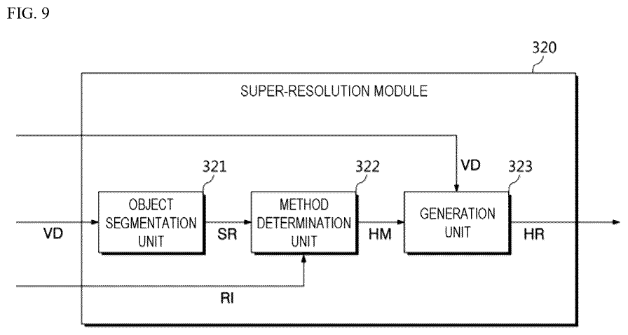

The weights of the nodes and edges between the input nodes and output nodes that constitute the NNM may be updated by the training process of the neural network. In addition, as described below, the parameters input or output to or from the NNM may be additionally expanded to various data in addition to video data (VD of FIG. 11), a segmentation result (SR of FIG. 11), and a high-resolution satellite image (HR of FIG. 9).

Referring back to FIG. 1, the server 300 may be a workstation, a data center, an internet data center (IDC), a direct attached storage (DAS) system, a storage area network (SAN) system, a network attached storage (NAS) system, and a redundant array of inexpensive disks or redundant array of independent disks (RAID) system, but the embodiment of the present invention is not limited thereto.

The communication network 400 serves to connect the user terminal 100 and the external database 200 to the server 300. In other words, the communication network 400 refers to a communication network that provides a connection path so that the server 300 may transmit and receive data to and from the user terminal 100 and the external database 200. The network 400 may include, for example, wired networks such as local area networks (LANs), wide area networks (WANs), metropolitan area networks (MANs), and integrated service digital networks (ISDNs) or wireless networks such as wireless LANs, code division multiple access (CDMA), Bluetooth, and satellite communication, but the scope of the present disclosure is not limited thereto.

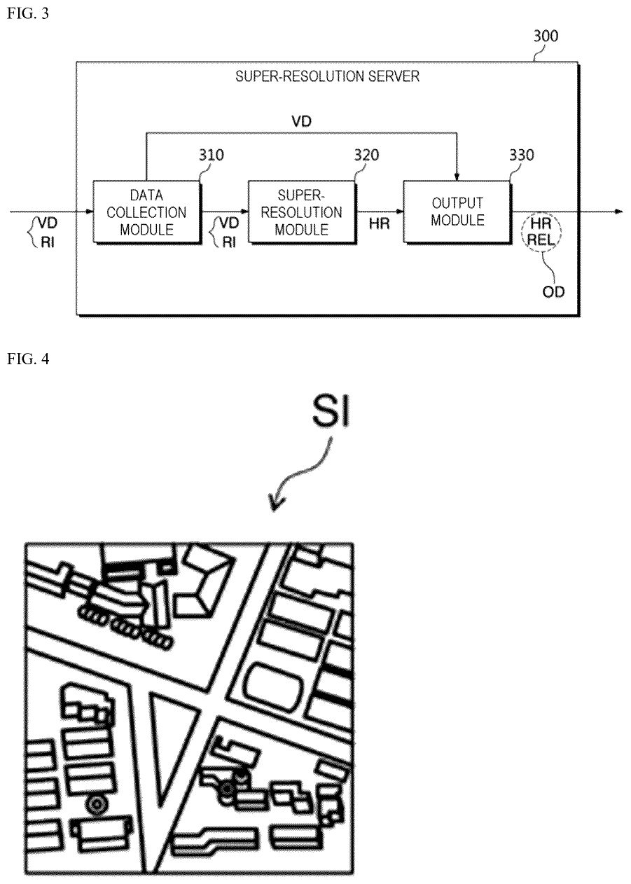

Hereinafter, the operation of the server 300 will be described with reference to FIGS. 3 to 21.

FIG. 3 is a block diagram of the super-resolution server according to some embodiments of the present invention.

Referring to FIGS. 1 and 3, the server 300 according to some embodiments of the present invention may include a data collection module 310, a super-resolution module 320, and an output module 330. However, the embodiments of the present invention are not limited thereto, and one of the data collection module 310, the super-resolution module 320, and the output module (330) included in the server 300 may be omitted and the server 300 may be implemented, or another configuration not illustrated in FIG. 3 may be included and implemented in the server 300.

The data collection module 310 may receive video data (hereinafter referred to as “VD”) and requirement information (hereinafter referred to as “RI”). For example, the data collection module 310 may receive requirement information (RI) from the user terminal 100 and may receive the VD from the external database 200.

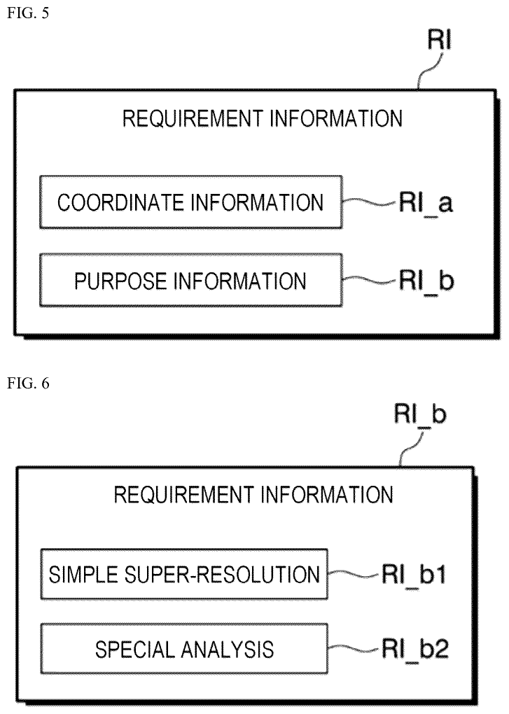

Hereinafter, the VD according to some embodiments of the present invention will be described with reference to FIG. 4, and the RI according to some embodiments of the present invention will be described with reference to FIGS. 5 to 7.

FIG. 4 is a diagram illustrating video data according to some embodiments of the present invention.

Referring to FIGS. 1, 3, and 4, the VD according to some embodiments of the present invention may include a video or image captured from a satellite located at a predetermined height from the ground.

As provided in some examples, the VD may include at least one of a satellite image (hereinafter referred to as “SI”) captured from a satellite, an aerial image captured from an aircraft, and a drone image captured from a drone, but the embodiment of the present invention is not limited thereto.

Hereinafter, for convenience of description, description will be provided by assuming that the VD is the SI.

The SI may be the video data captured from the satellite.

For example, the SI may include a satellite image captured using each of a plurality of channels. For example, the SI may include an electro-optical image, a multi-spectral image, etc. For example, the SI may include a satellite image for an RGB channel, a satellite image for a synthetic aperture radar (SAR) channel, a satellite image for a near-infrared (NIR) channel, etc. However, the embodiment of the present invention is not limited thereto.

Since such an SI is data captured at a very high altitude from the ground, the SI may have low resolution. That is, the SI may have low resolution due to the physical limitations of the capturing environment.

In the case of such low-resolution SI, the accuracy of analysis (e.g., vegetation analysis and the like) through the SI may be low, so there is a need for the SI to secure a resolution higher than a critical value for data analysis and the like through the SI.

Accordingly, the server 300 according to some embodiments of the present invention may perform the super-resolution task to improve the resolution of the SI as described below.

FIGS. 5 to 7 are diagrams for describing requirement information according to some embodiments of the present invention.

Referring to FIGS. 1, 3, and 5 to 7, the RI according to some embodiments of the present invention may be information reflecting the user's needs related to the super-resolution of the VD.

As provided in some examples, the RI may include coordinate information RI_a and purpose information RI_b as illustrated in FIG. 5.

The coordinate information RI_a may be information related to coordinates of an area in the VD where a user desires the super-resolution. In other words, the coordinate information RI_a may be information related to coordinates of an area where the user desires to secure a high-resolution satellite image.

The purpose information RI_b may be information related to a purpose that the user wants to achieve through the high-resolution satellite image. In other words, the purpose information RI_b may include information related to the reason, purpose, etc. for which the user super-resolves the VD at a location corresponding to the corresponding coordinate information RI_a.

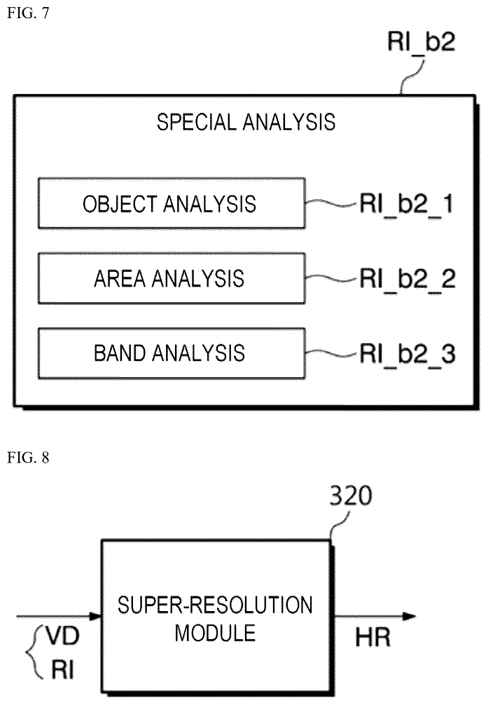

For example, the purpose information RI_b may include simple super-resolution RI_b1 and special analysis RI_b2 as illustrated in FIG. 6. In this case, the purpose information RI_b may include a user's selection (e.g., click, touch, etc.) for either the simple super-resolution RI_b1 or the special analysis RI_b2.

The simple super-resolution RI_b1 may mean that the user simply wants to visually check the high-resolution satellite image for the VD. In other words, the fact that the user terminal 100 transmits the simple super-resolution RI_b1 as the purpose information RI_b to the server 300 may mean that the user simply needs the high-resolution satellite image for visibility of the corresponding VD.

The special analysis RI_b2 may mean that the user wants to perform the special data analysis through the VD. In other words, the fact that the user terminal 100 transmits the special analysis RI_b2 as the purpose information RI_b to the server 300 may mean that the user will perform the special data analysis through the corresponding VD.

In this case, the special analysis RI_b2 may include object analysis RI_b2_1, area analysis RI_b2_2, and band analysis RI_b2_3 as illustrated in FIG. 7. In other words, the special analysis RI_b2 may be typed into the object analysis RI_b2_1, the area analysis RI_b2_2, and the band analysis RI_b2_3. That is, the purpose information RI_b may include the user's selection (e.g., click, touch, etc.) for any one of the object analysis RI_b2_1, the area analysis RI_b2_2, and the band analysis RI_b2_3 in relation to the special analysis RI_b2.

The object analysis RI_b2_1 may mean that the user wants to perform the data analysis (e.g., detection, tracking, etc.) on an object (e.g., car and the like) included in the VD through the VD. In other words, the fact that the user terminal 100 transmits the object analysis RI_b2_1 among the special analyses RI_b2 as the purpose information RI_b to the server 300 may mean that the user will perform data analysis on at least one object included in the VD through the corresponding VD.

In this case, the data collection module 310 may output guide information that guides a minimum resolution of the VD to the user terminal 100. That is, a minimum resolution value (e.g., 0.5 m for a car) that may secure reliability in the VD may be determined in advance for each object to be analyzed. In this case, the data collection module 310 may guide the minimum resolution value of the VD according to an object that the user wants to analyze when the user terminal 100 selects the object analysis RI_b2_1 as the purpose information RI_b.

The area analysis RI_b2_2 may mean that the user wants to perform the data analysis on an area (e.g., the area of the road) occupied by a specific object (e.g., a road) included in the VD through the VD. In other words, the fact that the user terminal 100 transmits the area analysis RI_b2_2 among the special analyses RI_b2 as the purpose information RI_b to the server 300 may mean that the user will perform data analysis on an area of the specific object included in the VD through the corresponding VD.

The band analysis RI_b2_3 may mean that the user wants to perform the data analysis on a band (e.g., normalized difference vegetation index (NDVI)) related to the specific object (e.g., vegetation) included in the VD through the VD. In other words, the fact that the user terminal 100 transmits the band analysis RI_b2_3 among the special analyses RI_b2 as the purpose information RI_b to the server 300 may mean that the user will perform data analysis on a band related to the specific object included in the VD through the corresponding VD.

Referring back to FIGS. 1 and 3, the data collection module 310 may transmit the received VD and RI to other components within the server 300. For example, the data collection module 310 may transmit the VD to the super-resolution module 320 and the like.

The super-resolution module 320 may generate the high-resolution satellite image (high-resolution satellite image, hereinafter referred to as “HR”) based on the VD and the RI.

In some examples, the super-resolution module 320 may generate a high-resolution satellite image (HR) by super-resolving the VD according to the RI.

Hereinafter, the operation of the super-resolution module 320 according to some embodiments of the present invention will be described with reference to FIGS. 8 to 19.

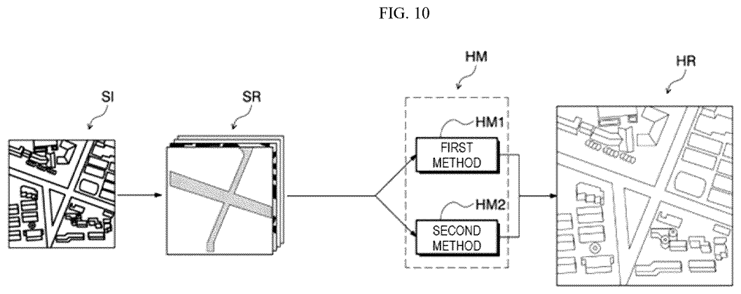

FIG. 8 is a block diagram of a super-resolution module according to some embodiments of the present invention. FIG. 9 is a detailed block diagram of the super-resolution module according to some embodiments of the present invention. FIG. 10 is a conceptual diagram for describing an operation of the super-resolution module according to some embodiments of the present invention.

Referring to FIGS. 1 and 3 to 10, the super-resolution module 320 may generate the HR based on the VD and the RI. In FIG. 10, for convenience of description, the VD is illustrated as the SI.

In some examples, as illustrated in FIG. 9, the super-resolution module 320 may include an object segmentation unit 321, a method determination unit 322, and a generation unit 323. The object segmentation unit 321 may segment the object included in the VD. In other words, the object segmentation unit 321 may perform object segmentation on the VD to generate a segmentation result (hereinafter referred to as “SR”). FIG. 10 illustrates several examples of the SR according to the object segmentation, but it is to be understood that the present invention is not limited thereto.

As provided in several examples, the object segmentation unit 321 may analyze the VD, identify the object included in the VD, and then perform the object segmentation by distinguishing the identified objects from each other.

Hereinafter, the operation of the object segmentation unit 321 according to several embodiments of the present invention will be described in more detail with reference to FIGS. 11 to 13.

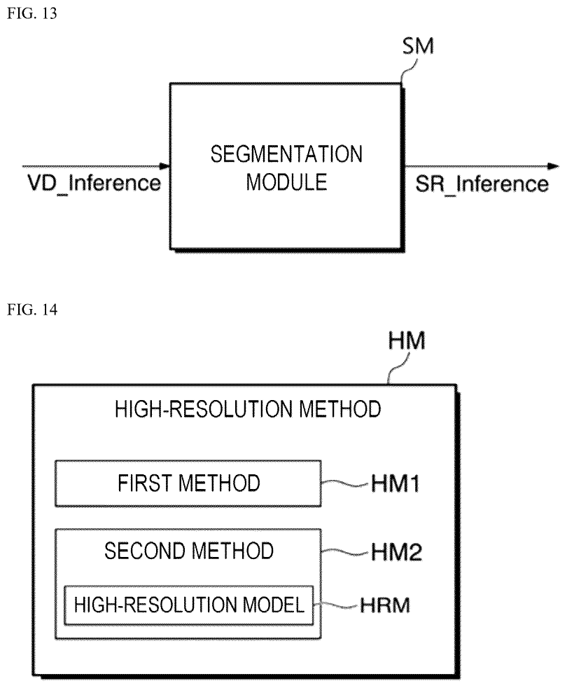

FIG. 11 is a detailed block diagram of an object segmentation unit included in the super-resolution module according to some embodiments of the present invention. FIGS. 12 and 13 are diagrams for describing a learning phase and an inferencing phase of the segmentation model used by the object segmentation unit according to some embodiments of the present invention.

Referring to FIGS. 1 and 3 to 13, the object segmentation unit 321 according to some embodiments of the present invention may generate the SR by segmenting the objects included in the VD.

For example, the object segmentation unit 321 may generate the SR for the VD. That is, the object segmentation unit 321 may perform the object segmentation on the VD as illustrated in FIG. 10 to generate the SR.

In this case, the object segmentation unit 321 may generate the SR using the segmentation model (hereinafter referred to as “SM”). For example, the object segmentation unit 321 may output the SR by inputting the VD into the SM. In this case, the SM may include a semantic segmentation model. For example, the SM may be a segment anything model (SAM), a distillation with NO labels model (DINO model), or a combination or variation model thereof. However, the embodiment of the present invention is not limited thereto, and the SM may include a fully convolutional network (FCN) model, a U-Net model, a DeepLab model, a mask R-CNN model, a SegNet model, etc.

When the VD is input, the SM may be pre-trained to generate the SR by identifying the objects included in the VD. In other words, the SM may be trained through a learning phase and perform a calculation task based on the training result of the learning phase in an inferencing phase.

More specifically, as illustrated in FIG. 12, the SM may be trained to output SR_learn for training by detecting and segmenting objects included in VD_learn for training when the VD_learn for training is input in the learning phase. That is, the SM may use the VD_learn for training and the SR_learn for training as a training data set in the learning phase.

In this case, the SR_learn for training may be data input from an administrator of the server 300. In other words, the SR_learn for training may be data input from the administrator of the server 300 to match the VD_learn for training as the training data.

In this case, the SR_learn for training may be used as correct data, i.e., labeling data. In other words, in the learning phase of the SM, the SR_learn for training input from the administrator of the server 300 may be used as the labeling data.

That is, the SM may be trained in a supervised learning manner in which the VD_learn for training is input into the input terminal and the SR_learn for training is applied to the output terminal. However, this is only one example, and the present invention is not limited thereto. Thereafter, as illustrated in FIG. 13, in the inferencing phase, when the VD_inference is input as input data, the SM may output the SR_inference as a result of detecting and segmenting the objects included in the corresponding VD_inference.

Referring back to FIGS. 1 and 3 to 10, the object segmentation unit 321 may transmit the SR to the method determination unit 322.

The method determination unit 322 may determine a high-resolution method, (hereinafter referred to as “HM”), which is a method of performing super-resolution, based on the SR and the required information RI. In other words, the method determination unit 322 may select the HM, which is a method of super-resolving VD, based on the SR and the RI.

Hereinafter, the operation of the method determination unit 322 according to some embodiments of the present invention will be described with reference to FIGS. 14 to 19.

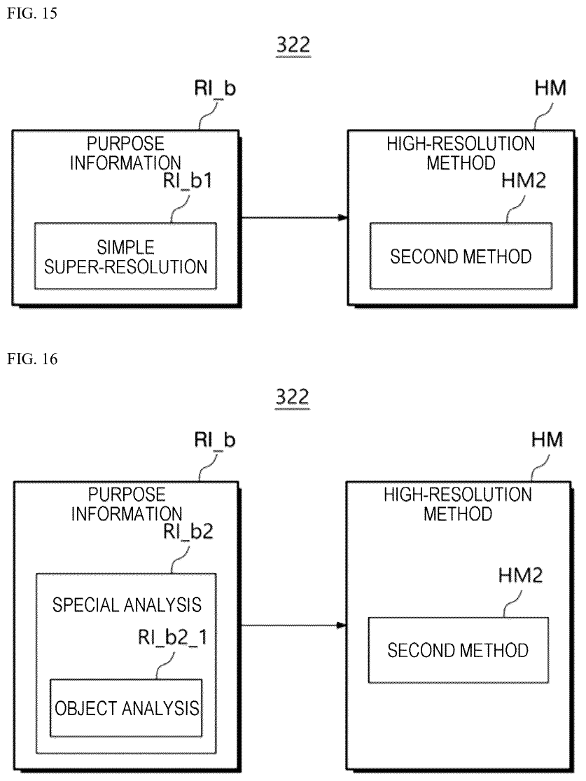

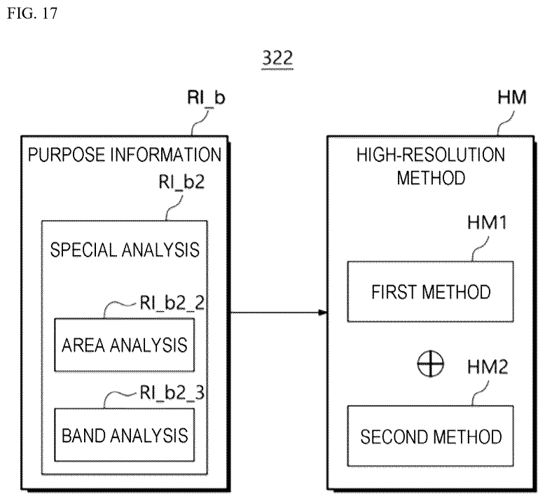

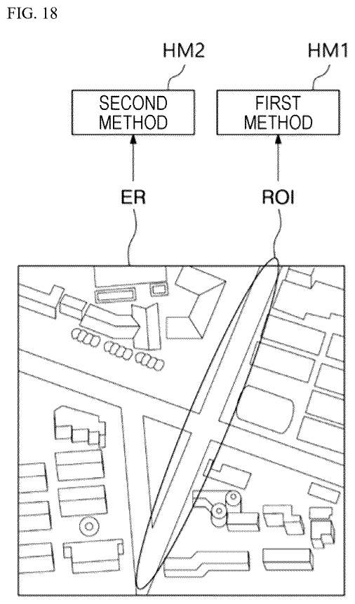

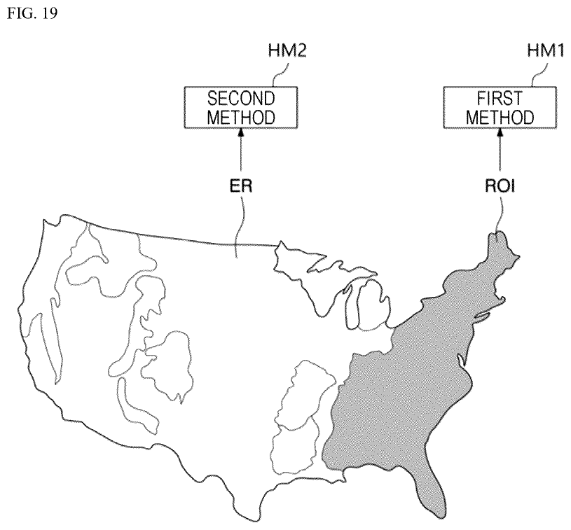

FIG. 14 is a diagram for describing the super-resolution method according to some embodiments of the present invention. FIG. 15 is a diagram for describing the operation of the method determination unit when the purpose information constitutes simple super-resolution according to some embodiments of the present invention. FIG. 16 is a diagram for describing the operation of the method determination unit when the purpose information constitutes object analysis according to some embodiments of the present invention. FIG. 17 is a diagram for describing the operation of the method determination unit when the purpose information constitutes area analysis or band analysis according to some embodiments of the present invention. FIG. 18 is a conceptual diagram for describing the operation of the method determination unit when the purpose information constitutes road area analysis according to some embodiments of the present invention. FIG. 19 is a conceptual diagram for describing the operation of the method determination unit when the purpose information constitutes vegetation band analysis according to some embodiments of the present invention.

Referring to FIGS. 1, 3 to 10, and 14 to 19, the method determination unit 322 may determine the HM for the VD based on the SR and the RI.

In this case, the HM may include a first method HM1 and a second method HM2 as illustrated in FIG. 14.

The first method HM1 may be the super-resolution method based on up-scaling. For example, the first method HM1 may be a method of enlarging an image based on the existing pixels of the VD. For example, the first method HM1 may include techniques such as bilinear interpolation and bicubic interpolation or modified forms thereof.

In the case of the first method HM1, the super-resolution process is simple, and there is an advantage in that the object reliability before and after performing the super-resolution is increased, but there is a disadvantage in that the effect of improving the resolution may be somewhat insufficient.

The second method HM2 may be a super-resolution method based on a high-resolution model (hereinafter referred to as “HRM”) using a neural network. For example, the second method HM2 may be a super-resolution method using a generative artificial intelligence model (e.g., ChatGPT, diffusion model, GAN model, etc.). In other words, the HRM used by the second method HM2 may be a generative artificial intelligence model or a modified form thereof.

The second method HM2 has the advantage of high visibility because the effect of resolution improvement is great, but there is the disadvantage in that the object reliability before and after the super-resolution, i.e., the reliability of super-resolution, may be somewhat low because the second method HM2 includes a process of virtually “creating” an object based on the existing VD.

In this way, the first method HM1 and the second method HM2 each have their unique advantages and disadvantages, and the method determination unit 322 may determine the HM using the RI that reflects the user's needs, thereby enabling the super-resolution suitable for the user's needs.

As provided in some examples, the method determination unit 322 may determine the HM based on the purpose information RI_b included in the RI. In other words, the method determination unit 322 may determine the HM for the VD to be at least one of the first method HM1 and the second method HM2 based on the purpose information RI_b.

For example, as illustrated in FIG. 15, the method determination unit 322 may determine the second method HM2 to be the HM when the purpose information RI_b constitutes the simple super-resolution RI_b1. In other words, the method determination unit 322 may determine the second method HM2, which is the method using the HRM based on the generative artificial intelligence model, to be the HM when the user selects the simple super-resolution RI_b1 as the purpose information RI_b.

That is, when the user simply selects the purpose information RI_b as the simple super-resolution RI_b1 to improve the visibility of the VD, the degree of resolution improvement may be a more important factor than the reliability of the super-resolution, so the method determination unit 322 may determine the second method HM2 to be the HM according to the user's needs.

In another example, as illustrated in FIG. 16, the method determination unit 322 may determine the second method HM2 to be the HM when the purpose information RI_b constitutes the object analysis RI_b2_1. In other words, when the user selects the object analysis RI_b2_1 as the purpose information RI_b, the method determination unit 322 may determine the second method HM2, which uses the HRM based on the generative artificial intelligence model, to be the HM.

That is, when the user selects the purpose information RI_b as the object analysis RI_b2_1 for the analysis of the object (e.g., a vehicle) and the resolution of the VD is higher than the minimum resolution (e.g., 0.5 m), it may not be easy to separate regions because the size of the specific object, e.g., the vehicle, is very small. Accordingly, since the effect of the super-resolution may be poor in the case of the first method HM1, the method determination unit 322 may determine the second method HM2 to be the HM according to this resolution limitation and the user's purpose of using the VD.

In another example, as illustrated in FIG. 17, the method determination unit 322 may determine the result of combining the first method HM1 and the second method HM2 to be the HM when the purpose information RI_b constitutes the area analysis RI_b2_2 or the band analysis RI_b2_3 for a specific target. In other words, the method determination unit 322 may determine the result of combining the first method HM1, which is the method of using up-scaling, and the second method HM2, which is the method of using the HRM based on the generative artificial intelligence model, to be the HM when the user selects the area analysis RI_b2_2 or the band analysis RI_b2_3 for the specific target as the purpose information RI_b.

For example, the method determination unit 322 may determine the first method HM1 to be the HM for some of the plurality of regions included in the SR and determine the second method HM2 to be the HM for some regions other than the some regions among the plurality of regions. In other words, the method determination unit 322 may determine the first method HM1 to be the HM for some of the plurality of objects segmented in the SR and determine the second method HM2 to be the HM for objects other than the corresponding some objects.

In this case, the method determination unit 322 may determine a region of interest (hereinafter referred to as “ROI”) among the plurality of regions included in the SR based on a specific target that is the subject of the area analysis RI_b2_2 or the band analysis RI_b2_3, determine the first method HM1 to be the HM for the determined ROI, and determine the second method HM2 to be the HM for other regions (hereinafter referred to as “ER”) excluding the ROI.

In more detail, as illustrated in FIG. 18, when the type of the special analysis RI_b2 is the area analysis RI_b2_2 for a road, that is, when the specific target in the area analysis RI_b2_2 is the road, the method determination unit 322 may determine a region including the road to be the ROI, determine the first method HM1 to be the HM for the ROI including the road, and determine the second method HM2 to be the HM for other regions excluding the road.

Alternatively, in contrast, as illustrated in FIG. 19, when the type of the special analysis RI_b2 constitutes the band analysis RI_b2_3 for the vegetation, that is, when the specific target in the band analysis RI_b2_3 is the vegetation, the method determination unit 322 may determine a region including the vegetation to be the ROI, determine the first method HM1 to be the HM for the ROI including the vegetation, and determine the second method HM2 to be the HM for other regions excluding the vegetation.

In this way, the super-resolution may be performed on the specific target and the specific data to be analyzed through the first method HM1 to secure the reliability of the super-resolution, and the super-resolution may be performed on other targets through the second method HM2 to increase the visible effects of the super-resolution, thereby having the advantages of both the first method HM1 and the second method HM2.

Referring back to FIGS. 1 and 3 to 10, the method determination unit 322 may transmit the HM to the generation unit 323.

The generation unit 323 may perform the super-resolution on the VD according to the HM to generate the HR.

For example, the generation unit 323 may perform the super-resolution on the region (e.g., ROI of FIGS. 18 and 19) in which the HM is the first method HM1 from among the VD using a post-processing algorithm based on the up-scaling.

As provided in another example, the generation unit 323 may perform the super-resolution on the entire VD for which the HM is determined to be the second method HM2 (e.g., the purpose information RI_b of FIGS. 15 and 16 constitutes the simple super-resolution RI_b1 or the object analysis RI_b2_1) and/or the region (e.g., ER of FIGS. 18 and 19) for which the HM is the second method HM2 from among the VD.

In this case, when the purpose information RI_b constitutes the area analysis RI_b2_2 or the band analysis RI_b2_3 for the specific target as described above in FIGS. 17 to 19, that is, when the HM is a combination of the first method HM1 and the second method HM2, the generation unit 323 may perform post-processing to connect the region (e.g., ROI of FIGS. 18 and 19) where the super-resolution is performed through the first method HM1 and the region (e.g., ER of FIGS. 18 and 19) where the super-resolution is performed through the second method HM2 to generate the HR. In this case, the post-processing may include, for example, smoothing, image stitching, etc. that naturally connects images, but the embodiments of the present invention are not limited thereto.

Referring back to FIGS. 1 and 3, the super-resolution module 320 may transfer the generated HR to the output module 330.

The output module 330 may output the HR and the reliability information (hereinafter referred to as “REL”) for the HR as output data (hereinafter referred to as “OD”). In other words, the output module 330 may calculate the REL for the HR and then provide the REL together with the HR as the OD to the user terminal 100 and the like.

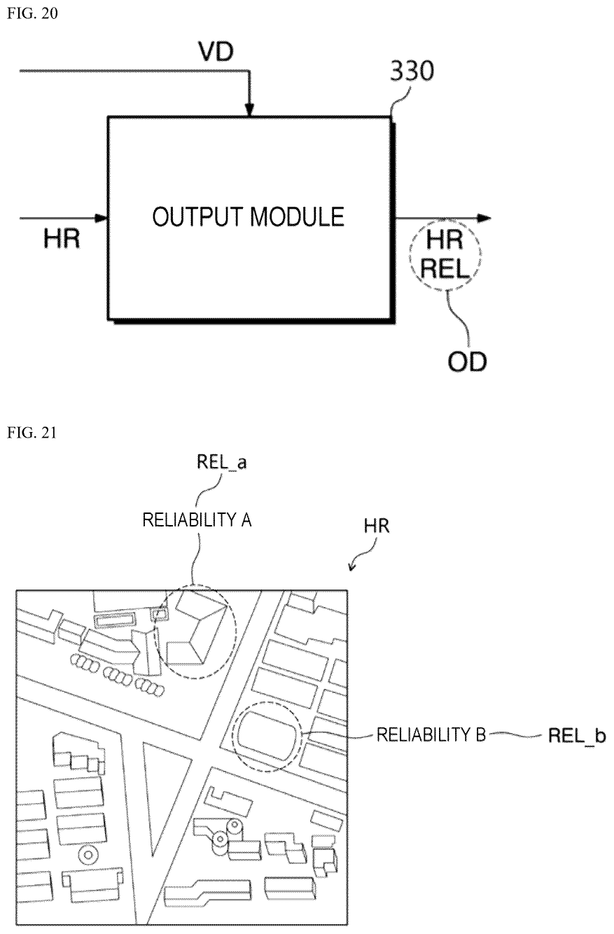

Hereinafter, the operation of the output module 330 according to some embodiments of the present invention will be described with reference to FIGS. 20 and 21.

FIG. 20 is a block diagram of the output module according to some embodiments of the present invention. FIG. 21 is a diagram for describing the reliability information according to some embodiments of the present invention.

Referring to FIGS. 1, 3, 20, and 21, the output module 330 may output the HR and the REL for the HR as the OD. In other words, the output module 330 may calculate the REL for the HR and then provide the REL together with the HR as the OD to the user terminal 100 and the like.

The REL may be information indicating accuracy, reliability, etc. of the HR, which is the result obtained by the super-resolution process. For example, the REL may be information related to how accurately the plurality of objects included in the VD, which is the original video, are reconstructed while minimizing the distortion of the VD, which is the original video, during the super-resolution process. In other words, the REL may be information that digitizes an error probability, a distortion level, etc. that may occur during the super-resolution process and displays the digitized error probability, distortion level, etc. for each object.

In FIG. 21, for convenience of description, reliability information REL_a for object A is illustrated as “reliability A”, and reliability information REL_b for object B is illustrated as “reliability B.”

In this case, the output module 330 may generate the REL based on the VD and the HR.

As provided in some examples, the output module 330 may generate the REL based on the difference between the VD and the HR.

For example, the output module 330 may compare the VD and the HR to generate the degree of correspondence, the probability of correspondence, etc. between the objects included in the VD and the objects included in the HR as the REL.

For example, the output module 330 may perform a detection on the plurality of objects included in each of the VD and the HR using a pre-trained detection model and calculate the degree of correspondence, similarity, etc. among the detection results of each object in each of the VD and the HR to generate the REL.

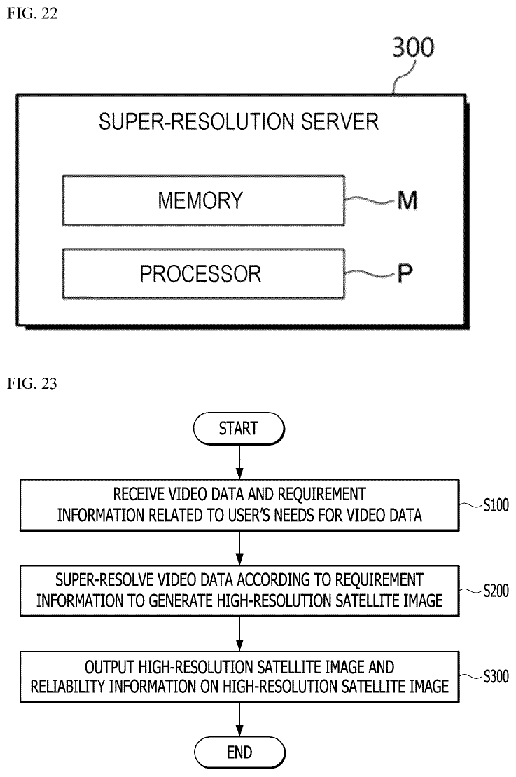

FIG. 22 is a block diagram of the super-resolution server according to some other embodiments of the present invention.

Referring to FIGS. 1 and 3 to 22, the server 300 according to some other embodiments of the present invention may include a memory (hereinafter referred to as “M”) and a processor (hereinafter referred to as “P”).

The memory M may include any non-transitory computer-readable storage medium. For example, the memory M may include a permanent mass storage device, such as a random access memory (RAM), a read only memory (ROM), a disk drive, a solid state drive (SSD), or a flash memory. As another example, the permanent mass storage device such as the ROM, the SSD, the flash memory, or the disk drive may be a separate permanent storage device distinct from the memory. In addition, the memory M may store an operating system (OS) and at least one program code.

These software components may be loaded from a computer-readable storage medium separate from the memory M. This separate computer-readable storage medium may be a storage medium that may be directly connected to a computer and may include, for example, a computer-readable storage medium such as a floppy drive, a disk, a tape, a digital versatile disc (DVD)/compact disc read-only memory (CD-ROM) drive, or a memory card. Alternatively, the software components may be loaded into the memory M via a communication device other than the computer-readable storage medium. For example, at least one program may be loaded into the memory M based on a computer program that is installed by files provided by developers or a file distribution system, which distributes installation files of an application, through a communication device.

The memory M may store commands, information, and/or data related to the operations of each component included in the server 300. For example, the memory M may store instructions that, when executed, enable the processor P to perform various operations described in this document. As provided in another example, the memory M may store various algorithms or models that may be used when the processor P generates the HR based on the VD, such as the segmentation model (SM of FIG. 11) and the high-resolution model (HRM of FIG. 14).

The processor P may process commands of a computer program by performing basic arithmetic, logic, and input/output calculation. Here, the commands may be provided by the memory M or an external device. The command may also be referred to as the above-described “instruction.” In this case, the processor P may be operatively connected to the memory M to perform the overall function of the server 300. In addition, the processor P may control the overall operation of other components included in the server 300.

In this case, the functions performed by each module included in the processor P may be performed by one processor or may be performed by separate processors. The processor P may execute calculations or data processing related to control and/or communication of at least one other component of the server 300. In addition, the processor P may be implemented as an array of a plurality of logic gates or may be implemented as a combination of a general-purpose microprocessor and a memory in which a program executable in the microprocessor is stored. For example, the processor P may include a general purpose processor, a central processing unit (CPU), a microprocessor, a digital signal processor (DSP), a controller, a microcontroller, a state machine, etc. In some environments, the processor P may refer to an application specific semiconductor (ASIC), a programmable logic device (PLD), a field programmable gate array (FPGA), etc. For example, the processor P may also refer to a combination of processing devices, such as a combination of a digital signal processor (DSP) and a microprocessor, a combination of a plurality of microprocessors, a combination of one or more microprocessors in combination with a DSP core, or any such other configurations.

In some examples, the processor P may receive the VD from an external database 200, and then super-resolve the received VD to generate the OD including the HR.

In order to provide description in detail, first, the processor P may receive the VD and the RI.

For example, the processor P may receive the RI from the user terminal 100 and may receive the VD from the external database 200. The RI may be information reflecting the user's needs related to the super-resolution of the VD. As provided in some examples, the RI may include the coordinate information RI_a and the purpose information RI_b as illustrated in FIG. 5. The coordinate information RI_a may be the information related to the coordinates of the area in the VD where the user desires the super-resolution. The purpose information RI_b may be the information related to the purpose that the user wants to achieve through the high-resolution satellite image. For example, the purpose information RI_b may include the simple super-resolution RI_b1 and the special analysis RI_b2 as illustrated in FIG. 6. In this case, the purpose information RI_b may include the user's selection (e.g., click, touch, etc.) for either the simple super-resolution RI_b1 or the special analysis RI_b2. In this case, the special analysis RI_b2 may include the object analysis RI_b2_1, the area analysis RI_b2_2, and the band analysis RI_b2_3 as illustrated in FIG. 7.

Next, the processor P may generate the HR based on the VD and the RI.

More specifically, first, the processor P may generate the SR by segmenting the object included in the VD. For example, the processor P may generate the SR for the VD. That is, the processor P may perform the object segmentation on the VD as illustrated in FIG. 10 to generate the SR. In this case, the processor P may generate the SR using the SM. For example, the processor P may output the SR by inputting the VD into the SM. In this case, the SM may include the semantic segmentation model.

Next, the processor P may determine the HM for the VD based on the SR and the RI. In this case, the HM may include the first method HM1 and the second method HM2 as illustrated in FIG. 14. The first method HM1 may be the super-resolution method based on up-scaling. For example, the first method HM1 may be the method of enlarging an image based on the existing pixels of the VD. For example, the first method HM1 may include techniques such as bilinear interpolation and bicubic interpolation or modified forms thereof. The second method HM2 may be the super-resolution method based on the HRM using a neural network. For example, the second method HM2 may be the super-resolution method using a generative artificial intelligence model (e.g., ChatGPT, diffusion model, GAN model, etc.). As provided in some examples, the processor P may determine the HM based on the purpose information RI_b included in the RI. In other words, the processor P may determine the HM for the VD to be at least one of the first method HM1 and the second method HM2 based on the purpose information RI_b. As illustrated in FIG. 15, the processor P may determine the second method HM2 to be the HM when the purpose information RI_b constitutes the simple super-resolution RI_b1. As provided in another example, as illustrated in FIG. 16, the processor P may determine the second method HM2 to be the HM when the purpose information RI_b constitutes the object analysis RI_b2_1. In another example, as illustrated in FIG. 17, the processor P may determine the result of combining the first method HM1 and the second method HM2 to be the HM when the purpose information RI_b constitutes the area analysis RI_b2_2 or the band analysis RI_b2_3 for the specific target. For example, the processor P may determine the first method HM1 to be the HM for some of the plurality of regions included in the SR and determine the second method HM2 to be the HM for some regions other than some regions among the plurality of regions. In this case, the processor P may determine the ROI from among the plurality of regions included in the SR based on the specific target that is the subject of the area analysis RI_b2_2 or the band analysis RI_b2_3, determine the first method HM1 to be the HM for the determined ROI, and determine the second method HM2 to be the HM for the ER excluding the ROI. In more detail, as illustrated in FIG. 18, when the type of the special analysis RI_b2 is the area analysis RI_b2_2 for a road, that is, when the specific target of the area analysis RI_b2_2 is the road, the processor P may determine a region including the road to be the ROI, determine the first method HM1 to be the HM for the ROI including the road, and determine the second method HM2 to be the HM for the ER excluding the road. Alternatively, in contrast, as illustrated in FIG. 19, when the type of the special analysis RI_b2 is the band analysis RI_b2_3 for the vegetation, that is, when the specific target in the band analysis RI_b2_3 is the vegetation, the processor P may determine a region including the vegetation to be the ROI, determine the first method HM1 to be the HM for the ROI including the vegetation, and determine the second method HM2 to be the HM for the ER excluding the vegetation.

Next, the processor P may perform the super-resolution on the VD according to the HM to generate the HR.

Subsequently, the processor P may output the HR and the REL for the HR as the OD. In other words, the processor P may calculate the REL for the HR and then provide the REL together with the HR as the OD to the user terminal 100 and the like. The REL may be the information indicating accuracy, reliability, etc. of the HR, which is the result obtained by the super-resolution process. For example, the REL may be information related to how accurately the plurality of objects included in the VD, which is the original video, are reconstructed while minimizing the distortion of the VD, which is the original video, during the super-resolution process. In other words, the REL may be the information that digitizes an error probability, a distortion level, etc. that may occur during the super-resolution process and displays the digitized error probability, distortion level, etc. for each object. In this case, the processor P may generate the REL based on the VD and the HR. As provided in some examples, the processor P may generate the REL based on the difference between the VD and the HR. For example, the processor P may compare the VD and the HR to generate the degree of correspondence, the probability of correspondence, etc. between the objects included in the VD and the objects included in the HR as the REL.

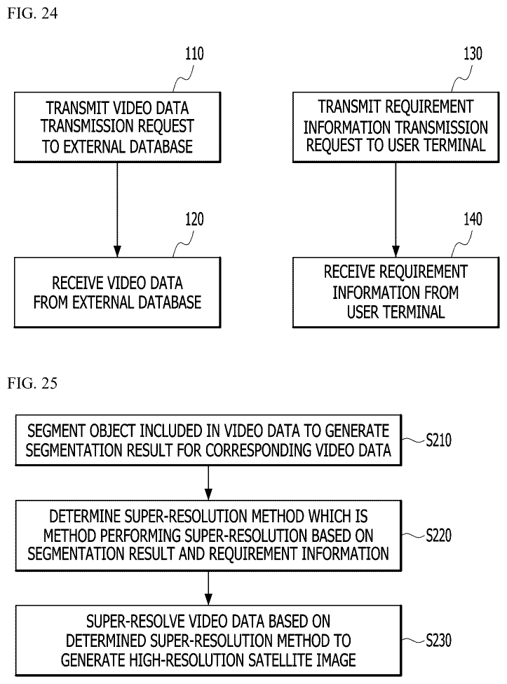

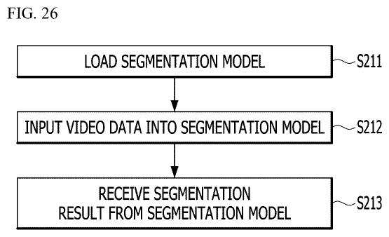

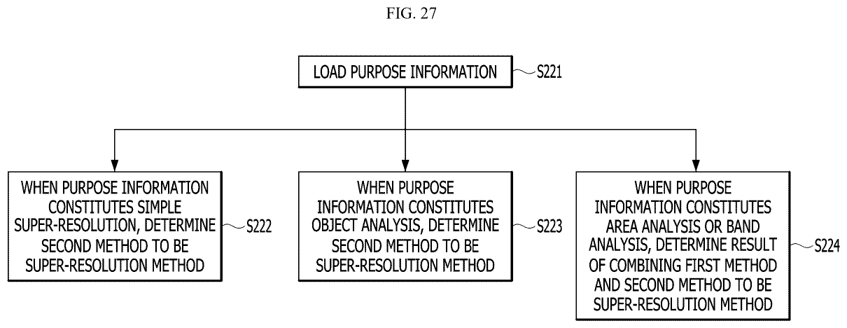

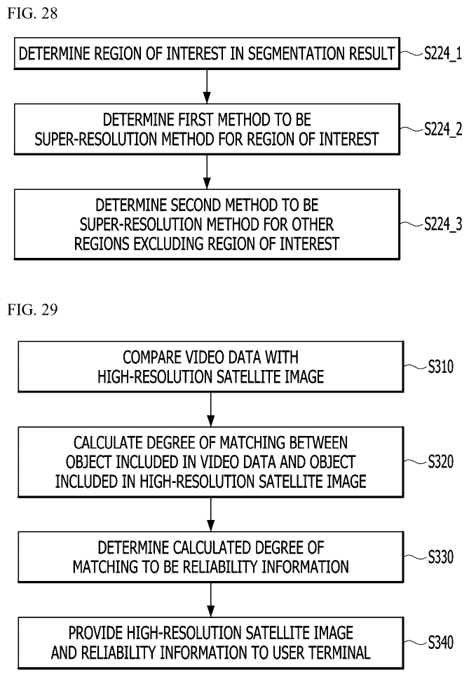

FIG. 23 is a flowchart of the super-resolution method according to some embodiments of the present invention. FIG. 24 is a detailed flowchart of operation S100 of FIG. 23 according to some embodiments of the present invention. FIG. 25 is a detailed flowchart of operation S200 of FIG. 23 according to some embodiments of the present invention. FIG. 26 is a detailed flowchart of operation S210 of FIG. 25 according to some embodiments of the present invention. FIG. 27 is a detailed flowchart of operation S220 of FIG. 25 according to some embodiments of the present invention. FIG. 28 is a detailed flowchart of operation S223 of FIG. 27 according to some embodiments of the present invention. FIG. 29 is a detailed flowchart of operation S300 of FIG. 23 according to some embodiments of the present invention. Each operation S100, S110 to S140, S200, S210 to S230, S211 to S213, S221 to S224, S223_1 to S223_3, S300, and S310 to S340 of FIGS. 23 to 29 may be performed by the server 300 of FIGS. 1, 3, and 22. Hereinafter, a description overlapping the above description will be briefly provided.

Referring to FIGS. 1 and 3 to 29, first, the server 300 may receive the VD and the RI related to the user's needs for the VD (S100).

As provided in some examples, the server 300 may transmit a video data transmission request to an external database 200 (S110) and thus receive the VD from the external database 200 (S120). In addition, the server 300 may transmit a requirement information transmission request to the user terminal 100 (S130) and thus receive the RI from the user terminal 100 (S140). The RI may be the information reflecting the user's needs related to the super-resolution of the VD. As provided in some examples, the RI may include the coordinate information RI_a and the purpose information RI_b as illustrated in FIG. 5. The coordinate information RI_a may be information related to coordinates of an area in the VD where the user desires the super-resolution. The purpose information RI_b may be the information related to the purpose that the user wants to achieve through the high-resolution satellite image. For example, the purpose information RI_b may include the simple super-resolution RI_b1 and the special analysis RI_b2 as illustrated in FIG. 6. In this case, the purpose information RI_b may include the user's selection (e.g., click, touch, etc.) for either the simple super-resolution RI_b1 or the special analysis RI_b2. In this case, the special analysis RI_b2 may include object analysis RI_b2_1, area analysis RI_b2_2, and band analysis RI_b2_3 as illustrated in FIG. 7.

Next, the server 300 may generate the HR by super-resolving the VD according to the RI (S200).

More specifically, the server 300 may generate the SR for the corresponding video data by segmenting the object included in the VD (S210). Specifically, the server 300 may load the SM (S211), input the VD into the SM (S212), and receive the SR from the SM (S213).

Subsequently, the server 300 may determine the HM, which is the method for performing super-resolution, based on the SR and the RI (S220). Specifically, the server 300 may load the purpose information RI_b (S221), determine the second method HM2 to be the HM when the purpose information RI_b constitutes the simple super-resolution RI_b1 (S222), determine the second method HM2 to be the HM when the purpose information RI_b constitutes the object analysis RI_b2_1 (S223), and determine the result of combining the first method HM1 and the second method HM2 to be the HM when the purpose information RI_b constitutes the area analysis RI_b2_2 or the band analysis RI_b2_3 for the specific target (S224). To describe the operation (S224) in more detail, the server 300 may determine the ROI from the SR (S224_1), determine the first method HM1 to be the HM for the ROI (S224_2) and determine the second method HM2 to be the HM for the ER excluding the ROI (S224_3). Next, the server 300 may perform the super-resolution on the VD based on the determined HM to generate the HR (S230).

Next, the server 300 may output the HR and the REL for the HR (S300).

In more detail, the server 300 may compare the VD and the HR (S310), calculate the degree of correspondence between the object included in the VD and the object included in the HR (S320), determine the calculated degree of correspondence to be the reliability information (REI) (S330), and provide the HR and the reliability information (REI) to the user terminal 100 (S340).

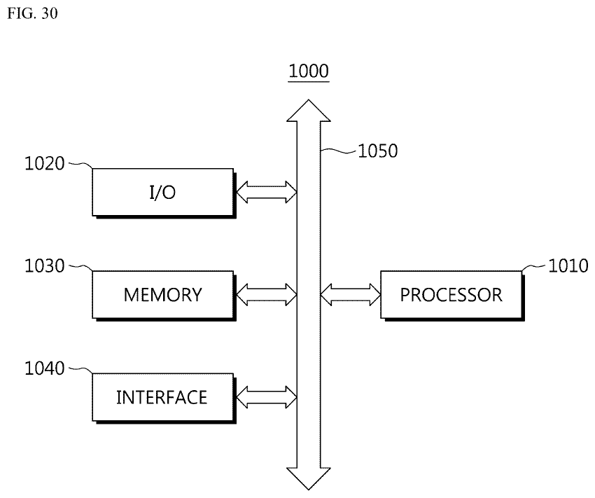

FIG. 30 is a diagram for describing a hardware implementation of the super-resolution server according to some embodiments of the present invention.

Referring to FIGS. 1 and 30, the server 300 according to some embodiments of the present invention may be implemented as an electronic device 1000. The electronic device 1000 may include a controller 1010, an input/output device (I/O) 1020, a memory device 1030, an interface 1040, and a bus 1050. The controller 1010, the I/O device 1020, the memory device 1030, and/or the interface 1040 may be coupled to each other via the bus 1050. In this case, the bus 1050 corresponds to a path through which data moves.

Specifically, the controller 1010 may include at least one of a central processing unit (CPU), a micro processor unit (MPU), a micro controller unit (MCU), a graphics processing unit (GPU), a microprocessor, a digital signal processor, a microcontroller, an application processor (AP), and a logic device capable of performing functions similar thereto.

The I/O device 1020 may include at least one of a keypad, a keyboard, a touchscreen, and a display device.

The memory device 1030 may store data and/or programs, etc.

The interface 1040 may perform a function of transmitting data to or receiving data from a communication network. The interface 1040 may be wired or wireless. For example, the interface 1040 may include an antenna, a wired/wireless transceiver, etc. Although not illustrated, the memory device 1030 may further include high-speed DRAM and/or SRAM as operation memory to enhance the operation of the controller 1010. The memory device 1030 may store a program or application therein.

The server 300 according to embodiments of the present invention may be a system formed by connecting the plurality of electronic devices 1000 to each other through a network. In this case, each module or a combination of modules may be implemented as the electronic device 1000. However, the present embodiment is not limited thereto.

In addition, the server 300 may be implemented as at least one of a workstation, a data center, an internet data center (IDC), a direct attached storage (DAS) system, a storage area network (SAN) system, a network attached storage (NAS) system, a redundant array of inexpensive disks or redundant array of independent disks (RAID) system, and an electronic document management (EDMS) system, but the present embodiment is not limited thereto.

In addition, the server 300 may transmit data to the user terminal 100 and the external database 200 through the network. The network may include a network using wired Internet technology, wireless Internet technology, and short-range communication technology. The wired Internet technology may include, for example, at least one of a local area network (LAN) and a wide area network (WAN).

The wireless Internet technology may include at least one of, for example, wireless LAN (WLAN), digital living network alliance (DMNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS), and 5G new radio (5G NR) technologies. However, the present embodiment is not limited thereto.

The short-range communication technology may include at least one of, for example, Bluetooth, radio frequency identification (RFID), infrared data association (IrDA), ultra-wideband (UWB), ZigBee, near field communication (NFC), ultra sound communication (USC), visible light communication (VLC), wireless fidelity (Wi-Fi), Wi-Fi direct, and 5G NR. However, the present embodiment is not limited thereto.

The server 300 communicating through the network may comply with technical standards and standard communication methods for mobile communication. For example, the standard communication method may include at least one of global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), and 5G NR. However, the present embodiment is not limited thereto.

The server and method for super-resolution and the system including the same according to some embodiments of the present invention have a new effect of performing super-resolution in a manner suitable for the user's needs as a result of varying the super-resolution method according to the user's request.

More specifically, the server and method for super-resolution and the system including the same according to some embodiments of the present invention have a new effect of varying the super-resolution method depending on whether the user requirements constitute simple super-resolution, object analysis, area analysis, or band analysis, thereby securing both reliability of the super-resolution results and visiblity of the super-resolution effects.

Moreover, the server and method for super-resolution and the system including the same according to some embodiments of the present invention can additionally display the object reliability according to the super-resolution, thereby enabling users to secure reliability in the super-resolution results. That is, the server and method for super-resolution and the system including the same according to some embodiments of the present invention can provide the user with the object reliability related to a degree of correspondence of the objects between the original data for the video data and the high-resolution data as the super-resolution results, thereby enabling the users to increase the reliability of the super-resolution task.

In addition to the above-described contents, specific effects according to some embodiments of the present invention are described together while describing specific matters for carrying out the present invention below.

The technical idea of the present embodiments has been merely described hereinabove illustratively, and those skilled in the art to which the present embodiments pertain may make various modifications and alterations without departing from the essential characteristics of the present embodiments. Accordingly, the present embodiments are directed to describing the spirit of the present embodiments rather than limiting the spirit of the present embodiments. The scope of the present embodiments is not limited to these embodiments. The scope of the present embodiments should be interpreted by the following claims, and it should be interpreted that all the technical ideas equivalent to the following claims fall within the scope of the present embodiments.

What is claimed is:

1. A super-resolution server, comprising:
a data collection module that receives video data and requirement information related to a user's needs for the video data;
a super-resolution module that super-resolves the video data according to the requirement information to generate a high-resolution satellite image; and
an output module that outputs the high-resolution satellite image and reliability information on the high-resolution satellite image.

2. The super-resolution server of claim 1, wherein the data collection module receives the video data from an external database that stores and manages the video data and receives the requirement information from a user terminal for the user.

3. The super-resolution server of claim 1, wherein the requirement information includes coordinate information related to a coordinate area that a user wants to analyze and purpose information related to a purpose that the user wants to achieve through the high-resolution satellite image.

4. The super-resolution server of claim 3, wherein the purpose information includes simple super-resolution that means only super-resolution of the video data and a selection of the user of one of special analyses that refers to specific data analysis through the video data.

5. The super-resolution server of claim 4, wherein the super-resolution module includes:
an object segmentation unit that segments an object included in the video data to generate a segmentation result for the corresponding video data;
a method determination unit that determines a super-resolution method which is a method of performing the super-resolution based on the segmentation result and the requirement information; and
a generation unit that super-resolves the video data according to the determined super-resolution method to generate the high-resolution satellite image.

6. The super-resolution server of claim 5, wherein the object segmentation unit segments the object using a segmentation model trained in advance based on a neural network to generate the segmentation result.

7. The super-resolution server of claim 6, wherein the segmentation model includes a semantic segmentation model.

8. The super-resolution server of claim 5, wherein the method determination unit determines one of a first method based on up-scaling and a second method based on a high-resolution model using a neural network to be the super-resolution method, and
the high-resolution model includes a generative artificial intelligence model.

9. The super-resolution server of claim 8, wherein the method determination unit determines the super-resolution method based on the purpose information included in the requirement information.

10. The super-resolution server of claim 9, wherein when the purpose information constitutes the simple super-resolution, the method determination unit determines the second method to be the super-resolution method.

11. The super-resolution server of claim 9, wherein, when the purpose information constitutes object analysis among the special analyses, the method determination unit determines the second method to be the super-resolution method.

12. The super-resolution server of claim 9, wherein when the purpose information constitutes area analysis or band analysis for a specific target from among the special analyses, the method determination unit determines a result of combining the first method and the second method to be the super-resolution method.

13. The super-resolution server of claim 12, wherein the method determination unit determines the first method to be the super-resolution method for some of a plurality of regions included in the segmentation result, and
determines the second method to be the super-resolution method for some regions other than the some of the plurality of regions.

14. The super-resolution server of claim 13, wherein the method determination unit determines a region of interest from among the plurality of regions included in the segmentation result based on the specific target,
determines the first method to be the super-resolution method for the determined region of interest, and
determines the second method to be the super-resolution method for other regions excluding the region of interest.

15. The super-resolution server of claim 14, wherein when the specific object is a road and a type of the special analysis is area analysis for the road,
the method determination unit determines a region including the road to be the region of interest,
determines the first method to be the super-resolution method for the region of interest including the road, and
determines the second method to be the super-resolution method for other regions excluding the road.

16. The super-resolution server of claim 14, wherein when the specific target is vegetation and a type of the special analysis is band analysis for the vegetation,
the method determination unit determines a region including the vegetation to be the region of interest,
determines the first method to be the super-resolution method for the region of interest including the vegetation, and
determines the second method to be the super-resolution method for other regions excluding the vegetation.

17. The super-resolution server of claim 1, wherein the output module generates the reliability information based on a difference between the video data and the high-resolution satellite image.

18. The super-resolution server of claim 17, wherein the output module compares the video data with the high-resolution satellite image to generate as the reliability information a probability of correspondence between an object included in the video data and the object included in the high-resolution satellite image.

19. A super-resolution server, comprising:
a memory that stores at least one instruction; and
at least one processor that executes the at least one instruction,
wherein the processor receives video data and requirement information related to a user's need for the video data,
super-resolves the video data according to the requirement information to generate a high-resolution satellite image, and
outputs the high-resolution satellite image and reliability information on the high-resolution satellite image.

20. A super-resolution system, comprising:
an external database that stores video data;
a super-resolution server that communicates with the external database to receive the video data;
a user terminal that transmits requirement information related to a user's needs for the video data to the super-resolution server; and
a communication network that performs communication between the external database, a user terminal, and the super-resolution server,
wherein the super-resolution server includes:
a memory storing at least one instruction, and
at least one processor that executes the at least one instruction, and
the processor receives the video data and the requirement information,
super-resolves the video data according to the requirement information to generate a high-resolution satellite image, and
outputs the high-resolution satellite image and reliability information on the high-resolution satellite image.
